(19) United States
(12) Patent Application Publication
(10) Pub. No.: US 2023/0301297 A1
(43) Pub. Date: Sep. 28, 2023

(54) AGROCHEMICAL FORMULATIONS

(71) Applicant: BASF SE, Ludwigshafen Am Rhein (DE)

(72) Inventors: Murat Mertoglu, Limburgerhof (DE); Marcus Annawald, Limburgerhof (DE); Stefan Bechtel, Limburgerhof (DE); Christian Sowa, Limburgerhof (DE)

(21) Appl. No.: 18/019,609

(22) PCT Filed: Jul. 27, 2021
(86) PCT No.: PCT/EP2021/070938

§ 371 Date: Feb. 3, 2023

(30) Foreign Application Priority Data
Aug. 7, 2020 (EP) 20190000.8

(51) Int. Cl. A01N 25/04; A01N 43/56; A01N 43/713; A01N 43/653; A01P 3/00

(52) U.S. Cl. CPC A01N 25/04; A01N 43/56; A01N 43/713; A01N 43/653; A01P 3/00

(57) ABSTRACT

Agrochemical composition comprising A) at least one pesticide A, B) at least one nonaqueous solvent S, C) a polymer P comprising units represented by formulae (I) and (II): Polymer P being a random polymer with respect to units (I) and (II); wherein Z (II) is a polymeric group comprising at least one type of vinyl monomer in polymerized form, where Z comprises as vinyl monomers at least one vinyl ester and optionally at least one N-vinyl lactam monomer; wherein said pesticide A and polymer P are completely dissolved in said solvent S at 20° C.

The present invention is directed to agrochemical compositions comprising
A) at least one pesticide A,
B) at least one nonaqueous solvent S,
C) a polymer P comprising units represented by formulae (I) and (II):

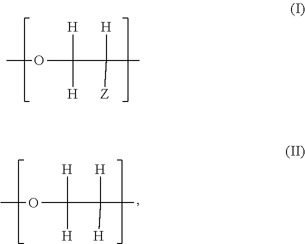

Polymer P being a random polymer with respect to units (I) and (II);
wherein Z is a polymeric group comprising at least one type of vinyl monomer in polymerized form, where Z comprises as vinyl monomers at least one vinyl ester and optionally at least one N-vinyllactam monomer;
wherein said pesticide A and polymer P are completely dissolved in said solvent S at 20° C.

There is a constant need for agricultural formulations that allow for pesticides to be delivered at high loadings, are environmentally friendly, are storage stable, easy in handling and have high biological efficacy.

Some pesticides are insoluble or not readily soluble in water. Such pesticides can for example be applied as part of formulations such as suspension concentrates, wettable powders, dry flowables, and other formulations that are mixed with water by the user prior to application.

These types of formulations have several disadvantages including dusting during handling, inhomogeneous mixing by the user, and settlement or clogging of spray tank screens during application. These formulations also have the disadvantage of requiring agitation or further mixing during application. Further, these formulations may require milling which can significantly increase manufacturing costs. Emulsifiable concentrate formulations are homogenous but require handling and emulsifying of non-water miscible solvents.

A dispersible concentrate (“DC”) is a liquid formulation that is applied as a solid dispersion after dilution in water. A water miscible organic fluid, or a mixture of multiple fluids, is usually used to dissolve water-insoluble or only partially soluble pesticidal agents. After dilution in water, the pesticidal agents precipitate out and disperse as micronized particles as the carrier fluid is dissolved in water. DC formulations contain a pesticide dissolved in a non-aqueous solvent. They are easy to handle since they do not contain a solid and typically have good biological activities. In addition to further enhancing the biological efficiency, it remains a challenge to provide DC formulations that contain high loadings of pesticide yet are storage stable and show little or no crystallization of the dissolved pesticides.

One of the challenges during the development of dispersion concentrates is to find compositions in which the dissolved active ingredients does not agglomerate and/or not crystalize upon dilution with water. If a dispersion concentrate is not stable after dilution with water, it is not suitable for the commercial use because the forming crystals will clog the spray equipment of farmers.

Thus, the objective of the present invention was to provide agricultural formulations that contain at least one pesticide in dissolved form in a nonaqueous solvent and at high loadings that are easy to handle and to dilute with water, show good biological efficiency and high storage stability.

This objective has been achieved by agrochemical compositions comprising
A) at least one pesticide A,
B) at least one nonaqueous solvent S,
C) a polymer P comprising units represented by formulae (I) and (II):

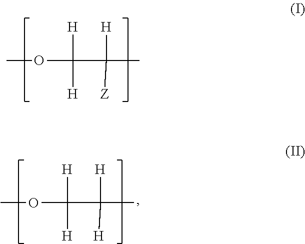

Polymer P being a random polymer with respect to units (I) and (II);
wherein Z is a polymeric group comprising at least one type of vinyl monomer in polymerized form, where Z comprises as vinyl monomers at least one vinyl ester and optionally at least one N-vinyllactam monomer;
wherein said pesticide A and polymer P are completely dissolved in said solvent S at 20° C.

Compositions of the invention are dispersible concentrate formulations.

Herein, the terms “formulation” and “composition” have the same meaning.

The term pesticide refers to at least one pesticide selected from the group of the fungicides, insecticides, nematicides, herbicides, safeners and/or growth regulators. Preferred pesticides are fungicides, insecticides, herbicides and growth regulators. Especially preferred pesticides are fungicides, insecticides and herbicides. Particularly preferred are fungicides, insecticides, herbicides. Mixtures of pesticides of two or more of the abovementioned classes may also be used. The skilled worker is familiar with such pesticides, which can be found, for example, in the Pesticide Manual, 14th Ed. (2006), The British Crop Protection Council, London.

Typically, pesticide A has a solubility in nonaqueous solvent S of at least 10 g/l at 20° C., preferably at least 50 g/l, more preferably at least 100 g/l (all solubilities given herein are at 20° C.). Preferably, the pesticide A has a solubility in water of 10 g/l or less at 20° C., preferably of 1 g/l or less, in each case at 20° C.

Suitable fungicides are, e.g., fungicides of the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenylcrotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles.

Suitable insecticides are, e.g., insecticides from the class of carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenone, or derivatives thereof.

Suitable herbicides are, e.g., herbicides of the classes of acetamides, amides, aryloxyphenoxy-propionates, benzamides, benzofuran, benzoic acids, benzothiadiazinones, bipyridylium, carbamates, chloroacetamides, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphoroamidates, phosphorodithioates, phthalamates, pyrazoles, pyridazinones, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

In a preferred embodiment, the pesticidal active ingredient is a fungicide.

According to one specific embodiment, the fungicide is selected from triazole fungicides, such as azaconazole, bitertanol, bromuconazole , cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 2 (2,4-difluorophenyl)-1,1-difluoro-3-(tetrazol-1-yl)-1-[5-[4-(2,2,2-trifluoroethoxy)phenyl]-2 pyridyl]propan-2-ol, 2-(2,4-difluorophenyl)-1,1-difluoro-3-(tetrazol-1-yl)-1-[5-[4-(trifluoromethoxy)phenyl]-2-pyridyl]propan-2-ol, 4-[[6-[2-(2,4-difluorophenyl)-1,1-difluoro-2-hydroxy-3-(5-sulfanyl-1,2,4-triazol-1-yl)propyl]-3-pyridyl]oxy]benzonitrile, ipfentrifluconazole, mefentrifluconazole, 2-(chloromethyl)-2-methyl-5-(p-tolylmethyl)-1-(1,2,4-triazol-1-ylmethyl)cyclopentanol; preferably epoxiconazole, mefentrifluconazole, prothioconazole; more preferably mefentrifluconazole.

In one embodiment the pesticides are selected from fluxapyroxad, difenoconazole, tebuconazole, prothioconazole, propiconazole, pyraclostrobin, azoxystrobin, kresoxim-methyl, trifloxystrobin, mefentrifluconzol, metyltetraprole, metrafenone, Saflufenacil, pendimetalin, atrazine, glyphosate, S-metolachlor, 2,4-D ester, isoxaflutole, Indazifalm, diflufenzopyr, dimethenamid-P, Cinmethylin, fipronil, Dinotefuran, Afidopyropen, Chlorantranilipyrol, and alpha cypermethrin.

In one embodiment the pesticides are selected from fluxapyroxad, pyraclostrobin, mefentrifluconzol, metyltetraprole and saflufenacil.

Typically, formulations of the invention comprise 1 to 50 wt % of pesticide A, preferably 2 to 40 wt %, more preferably 3 to 30 wt %, in each case based on the formulation.

It is possible that the formulation of the invention contains, in addition to pesticide A that is at 20° C. completely dissolved in nonaqueous solvent S, one or more further different pesticides that is for example dispersed in the solvent.

According to the invention, nonaqueous solvent S (herein also referred to as “solvent S”) can in principle be any solvent or solvent mixture that is capable of dissolving pesticide S in sufficiently high amounts, depending on the pesticide, and that is sufficiently miscible with water. Typically, nonaqueous solvent S has a solubility in water of 1 at g/l at 20° C., preferably at least 10 g/l, even more preferably at least 100 g/l. In one embodiment, nonaqueous solvent is miscible with water in all ratios.

Typically, nonaqueous solvent S has a dynamic viscosity of less than 100 mPas, preferably of less than 50 mPas or 10 mPas, as determined by as determined according to CIPAC MT 192 by using a rotational viscometer (apparent viscosity determined at shear rate of 100 s⁻¹). Nonaqueous solvent S may include small amounts of water as long as the liquid mixture maintains sufficient solubility of the pesticides in it. Nonaqueous solvent S typically contains less than 10 wt % water, preferably less than 5 wt % water, more preferably less thanl wt % water, in each case based on nonaqueous solvent S and water. In one preferred embodiment, nonaqueous solvent S contains no water. “No water” in this context means that such nonaqueous solvent S contains water only in an amount as it is typically present in commercial grades of such nonaqueous solvent S.

Examples of solvents that are in many cases suitable as nonaqueous solvents S are: alcohols (such as methanol, ethanol, n-propanol and isopropanol), (glycols such as ethylene glycol, diethylene glycol or triethylene glycol, 1,2-propylene glycol, 1,3 propylene glycol, 1,2-butylene glycol), glycerol, dimethyl sulfoxide, propylene glycol monomethyl ether, propylene glycol monoethyl ether, ethylene glycol monomethyl ether, 1-butoxy-2-propanol, dipropylene glycol monomethyl ether, cyclohexanone, acetophenone, benzyl alcohol, N,N-dimethyllactamide, gamma-butyrolactone, gamma-valerolactone, ethyl (S)-2-hydroxypropionate, N-acetyl morpholine, Rhodiasolv® Polar Clear (e.g. methyl-5-(dimethylamino)-2-methyl-5-oxopentanoate), Armid FM PC, N-octyl pyrrolidone, N-butyl pyrrolidone and esters (such as, for example, ethyl acetate, n-propyl acetate, isopropyl acetate, isobutyl acetate or butyl acetate), propylene carbonate, butylene carbonate and Tetrahydrofurfuryl alcohol or mixtures any of these solvents.

Preferred nonaqueous solvents S are dimethyl sulfoxide, propylene glycol monomethyl ether, propylene glycol monoethyl ether, acetophenone, benzyl alcohol, N,N-dimethyllactamide, gamma-butyrolactone, gamma-valerolactone, ethyl (S)-2-hydroxypropionate, ethylene carbonate, N-acetyl morpholine, N-butyl pyrrolidone, propylene carbonate, butylene carbonate and Tetrahydrofurfuryl alcohol, or mixtures thereof.

Typically, compositions of the invention comprise 20 to 95 wt % of nonaqueous solvent S, preferably 25 to 92 wt %, more preferably 30 to 80 wt %, in each case based on the composition.

Polymer P comprises units represented by formulae (I) and (II):

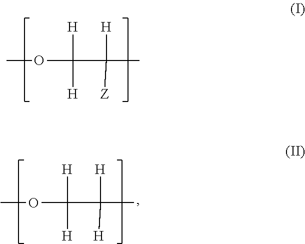

Polymer P being a random polymer with respect to units (I) and (II);
wherein Z is a polymeric group comprising at least one type of vinyl monomer in polymerized form, where Z comprises as vinyl monomers at least one vinyl ester and optionally at least one N-vinyllactam monomer;

When reference is made herein to polymeric group Z or another polymer “comprising” an ethylenically unsaturated monomer, this shall be understood to mean that said polymeric group or polymer comprises such monomer in polymerized form.

Preferably, said vinyl ester is represented by formula (III).

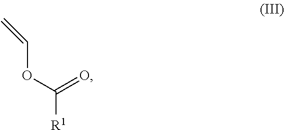

wherein R¹ is a C₁ to C₁₀, preferably a C₁ to C₅ hydrocarbon group.

Preferably, said vinyl ester is selected from vinyl propionate, vinyl acetate or a mixture thereof. Typically, polymeric group Z comprises at least 10 vinyl ester units that are preferably represented by formula (III). Preferably, polymeric group Z comprises 10 to 200, 20 to 100, 30 to 70 or 40 to 60 vinyl ester units that are preferably represented by formula (III).

Said N-vinyl lactam is preferably selected from N-vinyl pyrrolidone, N-vinyl caprolactam or mixtures thereof.

In one embodiment, polymeric group Z comprises vinyl ester and no N-vinyl lactam.

In one embodiment, polymeric group Z consists of vinyl esters.

In one embodiment, polymeric group Z comprises at least one vinyl ester and at least one N-vinyl lactam.

In one embodiment, polymeric group Z comprises at least one vinyl ester and at least one N-vinyl lactam, wherein the weight ratio of vinyl ether to N-vinyl lactam is 1:3 to 3:1.

In one embodiment, polymeric group Z comprises 10 to 200 units of vinyllactam, alternatively 20 to 100 or 30 to 70 units, in each case preferably selected from N-vinyl pyrrolidone, N-vinyl caprolactam or mixtures thereof.

In one embodiment, polymeric group Z comprises up to 20 mol % of vinyllactam, based on polymeric group Z.

In one embodiment, polymeric group Z comprises 10 to 200 units of vinyl acetate and/or vinyl propionate and no further monomers.

In one embodiment, polymeric group Z comprises 10 to 200 units of vinyl acetate and/or vinyl propionate and 10 to 200 units of N-vinyl pyrrolidone and/or N-vinyl caprolactam.

In one embodiment, polymeric group Z comprises 10 to 200 units of vinyl acetate and no further monomers.

In one embodiment, polymeric group Z comprises 10 to 200 units of vinyl acetate and 10 to 200 units of N-vinyl pyrrolidone.

In one embodiment, polymeric group Z comprises 10 to 200 units of vinyl acetate and 10 to 200 units of N-vinyl pyrrolidone in a molar ratio of 1:3 to 3:1.

In a preferred embodiment, polymeric group Z does not comprise any additional comonomers is addition to vinyl esters and vinyl lactames.

It is possible that polymeric group Z may comprise an additional comonomers.

Examples of suitable additional comonomers are vinyl carboxamides such as N-vinylformamide, N-vinyl-N-methyl formamide, N-vinyl acetamide, N-vinyl-N-methyl acetamide, N-vinyl-N-methyl propionamide, and N-vinyl propionamide. It is preferred to use N-vinylformamide and/or N-vinyl-N-methyl acetamide. The copolymerized monomer units of N-vinylformamide and/or N-vinyl-N-methyl acetamide may be partly or fully hydrolyzed.

Suitable further additional comonomers are also monoethylenically unsaturated mono-carboxylic and dicarboxylic acids or their anhydrides having 3 to 6 carbon atoms, such as acrylic acid, methacrylic acid, crotonic acid, maleic acid or anhydride, fumaric acid, itaconic acid or anhydride, and citraconic acid or anhydride.

Further suitable additional comonomers are the amides, esters, and nitriles of the aforementioned monoethylenically unsaturated C₃ to C₆ carboxylic acids, such as, for example, the amides acrylamide, methacrylamide, and also N-alkyl- and N,N-dialkylamides having alkyl radicals of 1 to 6 carbon atoms, such as N-methyl acrylamide, N,N-dimethylacrylamide, N-methylmethacrylamide, N,N-dimethylmethacrylamide, N-ethyl acrylamide, N-propyl acrylamide, tert-butyl acrylamide and tert-butylmethacrylamide, and also the basic (meth)acrylamides, such as 2-N,N-dimethylaminoethylacrylamide, 2-N,N-dimethylaminoethylmethacrylamide, 2-N,N-diethylaminoethylacrylamide, 2-N,N-diethylaminoethylmethacrylamide, 3-N,N-dimethylaminopropylacrylamide, 3-N,N-diethylaminopropylacrylamide, 3-N,N-dimethylaminopropylmethacrylamide and 3-N,N-diethylaminopropylmethacrylamide.

Other suitable additional comonomers are the esters of monoethylenically unsaturated carboxylic acids with C1 to C6 alcohols, such as methyl acrylate, methyl methacrylate, ethyl acrylate, and ethyl methacrylate, or with glycols or polyglycols, in each case only one OH group in the glycols and polyglycols being esterified with an ethylenically un-saturated carboxylic acid, such as hydroxyethyl acrylate, hydroxyethyl methacrylate, hydroxypropyl acrylates, hydroxy butyl acrylates, hydroxypropyl methacrylates, hydroxy butyl methacrylates, and also the (meth)acrylic monoesters of polyalkylene glycols with a molar weight of 200 to 10 000. Of further suitability are the esters of the aforementioned ethylenically unsaturated carboxylic acids with pyrrolidone derivatives, such as, for example, 2-(N-pyrrolidone)ethyl acrylate or 2-(N-pyrrolidone)ethyl methacrylate, and with amino alcohols, such as 2-N,N-dimethylaminoethyl acrylate, 2-N,N-dimethylaminoethyl methacrylate, 2-N,N-diethylaminoethyl acrylate, 2-N,N-diethylaminoethyl methacrylate, 3-N,N-dimethylaminopropyl acrylate, 3-N,N-dimethylaminopropyl methacrylate, 3-N,N-diethylaminopropyl acrylate, 3-N,N-diethylaminopropyl methacrylate, 4-N,N-dimethylaminobutyl acrylate, 4-N,N-diethylaminobutyl acrylate, 5-N,N-dimethylaminopentyl acrylate, dimethylaminoneopentyl methacrylate and 6-N,N-dimethylaminohexyl acrylate. The basic (meth)acrylates and (meth)acrylamides are used in the form of the free bases, of the salts with mineral acids, such as hydrochloric acid, sulfuric acid, and nitric acid, or in quaternized form. Examples of suitable quaternizing agents include dimethyl sulfate, methyl chloride, ethyl chloride, benzyl chloride or diethyl sulfate.

Additionally suitable as additional comonomers are N-vinyl imidazole and also substituted N-vinyl imidazoles, such as N-vinyl-2-methylimidazole, N-vinyl-4-methylimidazole, N-vinyl-5-methylimidazole, and N-vinyl-2-ethylimidazole, N-vinyl imidazolines, such as N-vinyl imidazoline, N-vinyl-2-methylimidazoline, and N-vinyl-2-ethylimidazoline, and also N-vinyl imidazolidinones, such as N-vinyl-2-imidazolidinone and N-vinyl-4-methyl-2-imidazolidinone. N-Vinyl imidazoles, N-vinyl imidazolines, and N-vinyl imidazolidinones are used not only in the form of the free bases but also in a form neutralized with mineral acids or in quaternized form, the quaternization being performed preferably using dimethyl sulfate, diethyl sulfate, benzyl chloride, methyl chloride or ethyl chloride.

Finally, monomers suitable as additional comonomers include those comprising sulfo groups, such as vinylsulfonic acid, allylsulfonic acid, methallylsulfonic acid, styrenesulfonic acid, 3-sulfopropyl acrylate, 3-sulfopropyl methacrylate, and 2-acrylamido-2-methylpropanesulfonic acid. The compounds containing acid groups can be used in the form of the free acids, the ammonium salts or the alkali metal and alkaline earth metal salts for the graft polymerization.

Among the additional comonomers N-vinyl imidazole, acrylic acid, methacrylic acid, methacrylamide, N,N-dimethylacrylamide, N-methylmethacrylamide, tert-butyl acrylamide, tert-butylmethacrylamide, dimethylaminoethyl methacrylamide, hydroxyethyl acrylate, 2-(N-pyrrolidone)ethyl acrylate, 2-(N-pyrrolidone)ethyl methacrylate, and 2-acrylamido-2-methyl propanesulfonic acid are preferably employed.

In one embodiment, polymeric group Z comprises up to 20, preferably up to 10 wt %, more preferably up to 5 w % or up to 2 wt % of additional comonomers, based on the polymeric group Z.

Advantageously in accordance with the invention, however, no monomers c) are employed.

In one embodiment, polymeric group Z makes up 45 to 75 wt % of polymer P. Preferably polymeric group Z makes up 50 to 70 wt % or 55 to 65 wt % of polymer P.

In one embodiment, polymer P comprises 1 to 30 units represented by formula (I), alternatively 1 to 15 and alternatively 1 to 10.

In one embodiment, polymer P bears in the terminal positions of the polyoxyalkylene chain a hydroxy or a C₁ to C₃₄ linear or branched alkyl ether group, preferably hydroxy or a C₁ to C₂₂ linear or branched alkyl ether group or a C₈ to C₂₂ linear or branched alkyl ether group.

Preferably, at least one of the terminal positions of the polyoxyalkylene chain is a hydroxy group.

In one embodiment all of the terminal positions of the polyoxyalkylene chain bear a hydroxy group.

In one embodiment, the polymer P comprises

1) at least one unit represented by the formula (I), wherein Z comprises at least 10 units represented by the formula (III), wherein R¹ is a C₁-C₅ hydrocarbon group; and

2) at least one unit represented by the formula (II).

In one embodiment, the polymer P comprises

1) at least one unit represented by the formula (I), wherein Z comprises at least 10 units represented by the formula (III), wherein R¹ is methyl; and

2) at least one unit represented by the formula (II).

In one embodiment, polymer P comprises 5 to 150 units represented by formula (II), alternatively 25 to 80.

In one embodiment, polymer P comprises 1 to 30 units represented by formula (I), and 5 to 150 units represented by formula (II).

In one embodiment, polymer P comprises 1 to 15 units represented by formula (I), and 25 to 80 units represented by formula (II).

In one embodiment, polymer P comprises 1 to 10 units represented by formula (I), and 25 to 80 units represented by formula (II).

The ratio of the molar number of units (I) to the combined number of units (I) and (II) is less than 0.2, preferably less than 0.1.

Typically, the combined average number of units (I) and (II) per polymer molecule is 6 to 200, preferably 10 to 180, more preferably 20 to 150.

Typically, polymer P has a number average molecular weight Mn from 1,000 to 100,000 g/mol, preferably 3,000 to 50,000 g/mol (calculated from OH number).

Polymer P is obtainable by free radical polymerization of a monomer mixture comprising i) an alcohol ethoxylate or polyethylene oxide, ii) a vinyl ester, as defined above and iii) optionally an N-vinyl lactam as defined above.

Polymer P is obtainable by well-known methods for graft polymerization. An advantageous process is for example given in WO 2007/138053, page 5, line 14 to page 10, line 25.

Suitable polyethylene oxide typically contains 6 to 200 units of ethylene oxide (“EO”), preferably 10 to 180, more preferably 20 to 150.

In one embodiment, suitable polyethylene oxide has an average molar mass Mn of 300 to 10000 g/mol, preferably 1000 to 9000 g/mol, more preferably 2000 to 8000 g/mol. In one embodiment, suitable polyethylene oxide has an average molar mass Mn of 4000 to 7000 g/mol. In one embodiment, suitable polyethylene oxide has an average molar mass Mn 300 to 1500 g/mol, or from 350 to 900 g/mol (all molecular masses of alkylene oxide containing polymers (like polyalkylene oxide or alcohol alkoxylates) given herein are, unless stated otherwise, calculated from OH number).

Suitable alcohol ethoxylates are obtainable by ethoxylation of alcohols with ethylene oxide.

The alcohol ethoxylate may comprise 6 to 200, preferably 10 to 100, and in particular 15 to 90 units of ethoxylate. In one embodiment, the alcohol ethoxylate comprise 15 to 50 units of ethoxylate,

The alcohol ethoxylate is usually based on a linear or branched, saturated or unsaturated C₁-C₃₄ alcohol (meaning that it was obtained by ethoxylation of a C₁-C₃₄ alcohol), preferably C₈-C₃₄ alcohol, more preferably a C₁₀-C22 alcohol, and in particular a C₁₂-C₁₈ alcohol.

The alcohol ethoxylates may have molecular weights Mn of from 200 to 10,000 D [Daltons], preferably 300 to 7,000 D, particularly preferably 400 to 5,000 D. In another preferred form the alcohol alkoxylates has a molecular weight Mn of from 300 to 2000 D, or from 350 to 1500 D.

The molecular weights are determined on the basis of the OH number. OH numbers as cited herein are determined as specified in DIN 53240.

In one embodiment, the alcohol alkoxylate comprises 6 to 100 units of ethoxylate, and the alcohol ethoxylate is based on a linear or branched, saturated or unsaturated C₈-C₃₄ alcohol.

In one embodiment, the alcohol ethoxylate comprise of 5 to 90 units of ethoxylate, and the alcohol ethoxylate is based on a linear or branched, saturated or unsaturated C₁₀-C₂₂ alcohol.

In one embodiment, the alcohol ethoxylate comprise of 50 to 90 units of ethoxylate, and the alcohol ethoxylate is based on a linear or branched, saturated or unsaturated C₁₂-C₁₈ alcohol.

In one embodiment, the alcohol ethoxylate comprise of 8 to 12 units of ethoxylate, and the alcohol ethoxylate is based on a linear or branched, saturated or unsaturated C₈-C₁₂ alcohol.

In one embodiment, polymer P is obtainable from a monomer mixture comprising

i) 10 to 80% by weight of polyethylene glycol and/or alcohol alkoxylate (e.g. C₈₋₂₂ alcohol ethoxylate),

ii) 5 to 70% by weight of vinyl ester (e.g. vinyl acetate),

iii) 0 to 60% by weight of N-vinyllactam (e.g. N-vinyl pyrrolidone), and

iv) up to 20%, preferably up to 10% by weight of additional comonomers,

wherein the sum of component i) to iv) adds up to 100%.

In one embodiment, polymer P is obtainable from a monomer mixture comprising

i) 10 to 80% by weight of polyethylene glycol and/or alcohol alkoxylate (e.g. C₈₋₂₂ alcohol ethoxylate),

ii) 5 to 70% by weight of vinyl ester (e.g. vinyl acetate),

iii) 0% by weight of N-vinyllactam (e.g. N-vinyl pyrrolidone), and

iv) up to 20%, preferably up to 10% by weight of additional comonomers,

wherein the sum of component i) to iv) adds up to 100%.

In one embodiment, polymer P is obtainable from a monomer mixture comprising

i) 30 to 50% by weight of polyethylene glycol and/or alcohol alkoxylate (e.g. C₈₋₂₂ alcohol ethoxylate),

ii) 48 to 70% by weight of vinyl ester (e.g. vinyl acetate),

iii) 0% by weight of N-vinyllactam (e.g. N-vinyl pyrrolidone), and

iv) up to 20%, preferably up to 10% by weight of additional comonomers,

wherein the sum of component i) to iv) adds up to 100%.

In one embodiment, polymer P is obtainable from a monomer mixture comprising

i) 25 to 35 wt % of polyethylene glycol with Mn=5000 to 7000 g/mol and 15 to 20 wt % of a C₈-C₁₂ alcohol ethoxylate (ethoxylation degree 8 to 12) %,

ii) 45 to 60% by weight of vinyl ester (e.g. vinyl acetate),

iii) 0% by weight of N-vinyllactam (e.g. N-vinyl pyrrolidone), and

iv) 0 to 2 wt %, preferably 0 wt % of additional comonomers, wherein the sum of component i) to iv) adds up to 100%.

In one embodiment, polymer P is obtainable from a monomer mixture comprising

i) 35 to 45 wt % of polyethylene glycol with Mn=5000 to 7000 g/mol,

ii) 55 to 65% by weight of vinyl ester (e.g. vinyl acetate),

iii) 0% by weight of N-vinyllactam (e.g. N-vinyl pyrrolidone), and

iv) 0 to 2 wt %, preferably 0 wt % of additional comonomers,

wherein the sum of component i) to iv) adds up to 100%.

In one embodiment, polymer P is obtainable from a monomer mixture comprising

i) 10 to 80% by weight of alcohol alkoxylate (e.g. C₈₋₂₂ alcohol ethoxylate),

ii) 5 to 70% by weight of vinyl ester (e.g. vinyl acetate),

iii) 5 to 60% by weight of N-vinyllactam (e.g. N-vinyl pyrrolidone), and

iv) up to 20%, preferably up to 10% by weight of additional comonomers,

wherein the sum of component i) to iv) adds up to 100%.

In one embodiment, polymer P is obtainable from:

i) 15 to 80% by weight of polyethylene glycol and/or an alcohol alkoxylate (e.g. C₈₋₂₂ alcohol ethoxylate),

ii) 10 to 45% by weight of vinyl ester (e.g. vinyl acetate),

iii) 10 to 45% by weight of N-vinyllactam (e.g. N-vinyl pyrrolidone), and

iv) up to 10% by weight of additional comonomers,

wherein the sum of component i) to iv) adds up to 100%.

In one embodiment, polymer P is obtainable from:

i) 10 to 50%, preferably 15 to 35% by weight of polyethylene glycol and/or an alcohol alkoxylate (e.g. C₈₋₂₂ alcohol ethoxylate),

ii) 20 to 60%, preferably 30 to 50% by weight of vinyl ester (e.g. vinyl acetate),

iii) 20 to 60%, preferably 30 to 50% by weight of N-vinyllactam (e.g. N-vinyl pyrrolidone), and

iv) up to 20%, preferably up to 10% by weight of additional comonomers,

wherein the sum of component i) to iv) adds up to 100%.

In one embodiment, polymer P is obtainable from:

i) 35 to 80%, preferably 45 to 75% by weight of polyethylene glycol and/or an alcohol alkoxylate (e.g. C₈₋₂₂ alcohol ethoxylate),

ii) 5 to 40%, preferably 10 to 30% by weight of vinyl ester (e.g. vinyl acetate),

iii) 5 to 40%, preferably 10 to 30% by weight of N-vinyllactam (e.g. N-vinyl pyrrolidone), and

iv) up to 20%, preferably up to 10% by weight of additional comonomers,

wherein the sum of component i) to iv) adds up to 100%.

In one embodiment, polymer P is obtainable from:

i) 20 to 25% by weight of an alcohol ethoxylate (e.g. C₁₆₋₁₈ alcohol ethoxylate with an ethoxylation degree of 70 to 90),

ii) 35 to 40% by weight of vinyl acetate,

iii) 35 to 40% by weight of N-vinyl pyrrolidone, and

iv) 0 to 2 wt %, preferably 0% by weight of additional comonomers,

wherein the sum of component i) to iv) adds up to 100%.

Usually, the components i), ii), iii) and optionally the amount of the additional comonomers iv) add up to 100% in the monomer mixture. Preferably, the components i), ii), and iii) add up to 100% in the monomer mixture. It will be appreciated that mixtures of two or more additional comonomers can also be used.

The amount of the polymer P is usually in the range of from 5 to 1000 wt %, preferably from 10 to 500 wt %, more preferably from 20 to 100 wt %, based on the weight of the active.

The composition may comprise 1 to 60 wt %, preferably 5 to 40 wt %, more preferably 8 to 30 wt %, and in particular 10 to 20 wt % of polymer P.

The polymerization for obtaining polymer P is preferably carried out at temperatures from 60 to 100° C. Suitable nonaqueous organic solvents are, for example, alcohols such as methanol, ethanol, n-propanol and isopropanol, and glycols such as ethylene glycol, diethylene glycol or triethylene glycol and glycerol. Further suitable solvents are esters such as, for example, ethyl acetate, n-propyl acetate, isopropyl acetate, isobutyl acetate or butyl acetate or other nonaqueous solvents S as described above.

Free-radical initiators are employed to initiate the polymerization. The amounts of initiator or initiator mixtures used, based on monomer employed, are between 0.01 and 10% by weight, preferably between 0.3 and 5% by weight. Depending on the nature of the solvent used, both organic and inorganic peroxides are suitable, such as sodium per-sulfate or azo initiators such as azobisisobutyronitrile, azo-bis(2-amidopropane) dihydrochloride or 2,2′-azobis(2-methylbutyronitrile). Examples of peroxide initiators are dibenzoyl peroxide, diacetyl peroxide, succinyl peroxide, tert-butyl perpivalate, tert-butyl perethylhexanoate, tert-butyl perneodecanoate, tert-butyl permaleate, bis-(tert-butyl per)cyclohexane, tert-butylperisopropyl carbonate, tert-butyl peracetate, 2,2-bis(tert-butylper)butane, dicumyl peroxide, di-tert-amyl peroxide, di-tert-butyl peroxide, p-menthane hydroperoxide, pinane hydroperoxide, cumene hydroperoxide, tert-butyl hydroperoxide, hydrogen peroxide and mixtures of said initiators. Said initiators can also be used in combination with redox components such as ascorbic acid. Particularly suitable initiators are tert-butyl perneodecanoate, tert-butyl perpivalate or tert-butyl per-ethylhexanoate.

The free-radical polymerization can place if appropriate in the presence of emulsifiers, if appropriate further protective colloids, if appropriate molecular weight regulators, if appropriate buffer systems and if appropriate subsequent pH adjustment using bases or acids.

Suitable molecular weight regulators are sulfhydryl compounds such as alkyl mercaptans, e.g. n-dodecyl mercaptan, tert-dodecyl mercaptan, thioglycerol, thioglycolic acid and esters thereof (e.g. 2-ethylhexyl thioglycolate), mercaptoalkanols such as mercaptoethanol. Further suitable regulators are mentioned for example in DE 197 12 247 A1, page 4. The necessary amount of the molecular weight regulators is in the range from 0 to 5% by weight based on the amount of (co)monomers to be polymerized. If regulators are used, the amount employed is in particular in the range from 0.05 to 2% by weight, particularly preferably 0.1 to 1.5% by weight. However, polymerization in the absence of a regulator is very particularly preferred.

The monomer, or the monomer mixture are introduced together with the initiator, which is generally present in solution, into a stirred reactor at the polymerization temperature (batch process) or if appropriate metered continuously or in a plurality of consecutive stages into the polymerization reactor (feed process). It is usual in the feed process for the reactor to be charged, before the start of the actual polymerization, besides the solvent (in order to make stirring of the reaction mixture possible) also with partial quantities, rarely the total quantity intended for the polymerization, of the starting materials such as emulsifiers, protective colloids, monomers, regulators etc. or partial quantities of the feeds (generally monomer feed or emulsion feed and initiator feed).

The polymerization can be carried out both under atmospheric pressure and in a closed reactor under elevated pressure. In this case it is possible to polymerize either under the pressure set up during the reaction, or the pressure can be adjusted by injecting a gas or evacuating. The pressure can also be controlled by partial decompression of the reactor into the condenser.

After the polymerization it is possible to employ generally known processes for reducing residual monomers. Examples of such processes are further addition of an initiator at the end of the polymerization, hydrolysis of vinyllactam monomers by adding acids, treatment of the polymer solution with solid phases such as ion exchangers, feeding in a monomer which copolymerizes well, membrane filtration and further customary methods.

The number of units represented by the formula (I) and by formula (II) substantially control chain length in the polymeric additive if polymer P is prepared according to the above described graft polymerization process. Furthermore, the number of units represented by the formula (I) and the formula (II), as well as the number of units present in Z and the number of alkyl lactam units substantially control a number average molecular weight polymer P. In one embodiment, polymer P has a molecular weight Mn of from 5,000 to 100,000 g/mol and alternatively from 15,000 to 50,000 g/mol. Polymer P may be terminated by hydroxy groups or alkylated on one terminal OH groups. Suitable alkyl radicals are branched or unbranched C₁- to 34-alkyl radicals.

In one embodiment polymer P is represented by formula (IV):

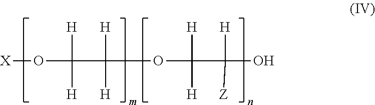

wherein X is hydrogen or a C₁-C₃₄ linear or branched alkyl group,
m is a number from 5 to 150,
n is a number from 1 to 30,
polymer P being a random polymer.
Z is defined as above,

Preferably, X is hydrogen or a C₁-C₃₄ linear or branched alkyl group or a C₈ to C₃₄ linear or branched alkyl group or a C₈ to C₂₂ linear or branched alkyl group.

Another aspect of the invention are agrochemical composition comprising
A) at least one pesticide A,
B) at least one nonaqueous solvent S,
C) At least one polymer P that is obtainable by free radical polymerization of a monomer mixture comprising i) an alcohol ethoxylate or polyethylene oxide, ii) a vinyl ester, and iii) optionally an N-vinyl lactam, and iv) optionally additional monomers,

in each case for components A) to C) and i) to iv) in the amounts and with the embodiments as described above;

wherein said pesticide A and polymer P are completely dissolved in said solvent S at 20° C.

In one embodiment, compositions of the invention typically comprise 0.5 wt % to 60 wt %, preferably 5 wt % to 50 wt % and more preferably 8 wt % to 45 wt % and especially preferably 15 wt % to 40 wt % of polymer P, in each case based on the composition. In one embodiment, polymer P is present in the composition in an amount of 0.5 to 10.0, alternatively from 0.5 to 5, and alternatively from 1 to 3 percent by weight, based on the total weight of the composition.

In a further preferred embodiment, the amount of polymer P is usually in the range of from 5 to 1000 wt %, preferably from 10 to 500 wt %, more preferably from 20 to 100 wt %, based on the weight of pesticide A.

Preferably, polymer P is present in the composition in an amount of 50 to 2000 wt %, based on the weight of the pesticide A.

Furthermore, compositions of the invention may contain other auxiliaries that function in various ways either in the formulation itself or when it is diluted with water, or when the product is applied. These auxiliaries may not be dissolved but dispersed in the carrier liquid; therefore, the DC may not always look like homogeneous clear solutions.

Suitable auxiliaries include liquid carriers, solid carriers or fillers, surfactants, dispersants, emulsifiers, wetters, adjuvants, solubilizers, penetration enhancers, adhesion agents, humectants, repellents, attractants, feeding, compatibilizers, bactericides, anti-freezing agents, anti-foaming agents, colorants, tackifiers and binders.

Dispersible concentrates often contain surfactants that make a uniform and stable dispersion of the precipitated solid particles.
Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).
Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.
Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.
Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.
Suitable adjuvants are compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.
Suitable bactericides are bronopol and isothiazolinone derivatives such as alkylisothiazolinones and benzisothiazolinones.
Suitable anti-foaming agents are silicones, long chain alcohols, and salts of fatty acids.
Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).
Suitable tackifiers or binders are polyvinylpyrrolidones, polyvinylacetates, polyvinyl alcohols, polyacrylates, biological or synthetic waxes, and cellulose ethers.

Compositions of the invention typically have a dynamic viscosity of 100 mPas or less, preferably 600 mPas or less, as determined according to CIPAC MT 192 by using a rotational viscometer (apparent viscosity determined at shear rate of 100 s-1).

In one embodiment, compositions of the invention comprise
A) 3% to 30% wt % of at least one pesticide A,
B) 25% to 92% wt % at least one nonaqueous solvent S,
C) 5 to 45 wt % of a polymer P;
D) 0 to 30 wt % of nonionic and/or anionic surfactants different from polymer P
E) 0 to 30 wt % of further additives.

In one embodiment, compositions of the invention comprise
A) 5% to 20% wt % of at least one pesticide A,
B) 30% to 80% wt % at least one nonaqueous solvent S,
C) 10 to 35 wt % of a polymer P;
D) 5 to 30 wt % of nonionic and/or anionic surfactants different from polymer P;
E) 0 to 30 wt % of further additives.

Another aspect of the present invention is a method for controlling phytopathogenic fungi and/or undesired plant growth and/or undesired attack by insects or mites and/or for regulating the growth of plants, where the composition of the invention is allowed to act on the particular pests, their habitat or the plants to be protected from the particular pest, the soil and/or on undesired plants and/or the useful plants and/or their habitat.

The copolymers and the compositions according to the invention are particularly important in various cultivated plants, such as cereals, e. g. wheat, rye, barley, triticale, oats or rice; beet, e.g. sugar beet or fodder beet; fruits, such as pomes, stone fruits or soft fruits, e. g. apples, pears, plums, peaches, almonds, cherries, strawberries, rasp-berries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cu-cumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bana-nas; vines (table grapes and grape juice grape vines); hop; turf; sweet leaf (also called Stevia); natural rubber plants or ornamental and forestry plants, such as flowers, shrubs, broad-leaved trees or evergreens, e. g. conifers; and on the plant propagation material, such as seeds, and the crop material of these plants.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

The term “cultivated plants” is to be understood as including plants which have been modified by breeding, mutagenesis or genetic engineering including but not limiting to agricultural biotech products on the market or in development. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or famesylated moieties or PEG moieties.
When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.
In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required.
When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.
Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.
The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.
According to one embodiment, individual components of the composition according to the invention such as parts of a kit or parts of a binary or ternary mixture may be mixed by the user himself in a spray tank and further auxiliaries may be added, if appropriate.
In a further embodiment, either individual components of the composition according to the invention or partially premixed components may be mixed by the user in a spray tank and further auxiliaries and additives may be added, if appropriate.
In a further embodiment, either individual components of the composition according to the invention or partially premixed components can be applied jointly (e.g. after tank mix) or consecutively.

The present invention offers the following advantages:

Compositions of the invention are physically and chemically stable for an extended period of time, ensuring a long shelf life for the product, even under environmentally stressful conditions. In particular, compositions of the invention show little or no tendency of the dissolved pesticide to crystallize.

They are suitable for treating crops and show excellent biological activity in combating pests. They are easy and economical to make and easy in their handling. Compositions of the invention have a low viscosity. They can be easily diluted with water to obtain a sprayable mixture.

### EXAMPLES

Materials Used

APEG 1: ethoxylated saturated linear C16C18 fat alcohol, degree of ethoxylation about 80, melting point about 56° C., HLB value about 18.5.

VP N-vinyl pyrrolidone

VAc vinyl acetate

Surfactant A alkoxylated branched C10-alcohol, degree of ethoxylation about 10 EA ethyl acetate solvent

tBPPiv tert. butyl perpivalate

Surfactant A Calcium dodecylbenzolsulfonate, 60 wt % in ethyl hexanol

Surfactant B Castor oil, ethoxylated

Surfactant C low foaming nonionic surfactant consisting of alkoxylated, predominantly unbranched fatty alcohols, and containing higher alkene oxides alongside ethylene oxide.

GPC: gel permeation chromatography

Preparation of Polymeric Additive A

Polyethylene glycol (0.44 kg, Mn 6000) was melted at 90° C. and 0.6 g of tert-butyl per-2-ethylhexanoate, dissolved in of tripropylene glycol, were added. 7.75 mol of vinyl acetate were added under stirring within 6 h (feed 1), as well as 7 g of tert-butyl peroxy-2-ethylhexanoate, dissolved in tripropylene glycol, within 6.5 h (feed 2), and also, beginning 3 h after the start of feed 1, 0.23 kg of Surfactant A within 3.5 h (feed 3) were metered in in parallel continuously with constant flow rates at a temperature of 90° C. After the end of feeds 2 and 3 and subsequent stirring at 90° C. for a further hour, 6 g of tert-butyl peroxy-2-ethylhexanoate, dissolved in tripropylene glycol, were added in 3 portions at 90° C. with further stirring for two hours in each case. A solids content of about 88% by weight was established by adding water. The resulting graft polymer (Polymeric additive A) had a K value of 17-19 (1 wt % polymer in aqueous sodium chloride (3 wt %) at 23 ° C.), Mw 36000, and Mn 20 000 (measured by gel permeation chromatography, PMMA standard).

Preparation of Polymeric Additive B

The reaction vessel containing 100 g APEG 1 and 25 g EA was gassed with nitrogen and heated to 77° C. Then one part of feed 2 (12.2 g tBPPiv, 50 g EA) was added and the mixture stirred for 15 min. Then feed 1 (160g VAc, 160 g VP, 120 g EA, 2.2 g 2-mercapto ethanol) and the rest of feed 2 were introduced in the reaction mixture. Feed 1 was introduced in 5 h, feed 2 was introduced in the course of 5.5 h. The reaction mixture was then kept at 77° C. for additional 3 h. Then feed 3 (200 g EA) was introduced and the reaction mixture was cooled down. Thereafter the reaction mixture was subject to steam distillation and EA was distilled off. Thereafter, benzyl alcohol was distilled off. The resulting polymer solution of graft polymer (Polymeric additive B) was 70% w/w in benzyl alcohol (a clear yellow solution). GPC measurements showed Mn=2.894 g/mol and Mw=6.514 g/mol.

### Examples DC 1 to DC 15: Dispersion Concentrates

The dispersion concentrates DC 1 to DC 15 were prepared by mixing the ingredients listed in the table 1 at 60° C. for 30 minutes. All mixtures yielded transparent solutions.

One of the challenges during the development of dispersion concentrates is to find compositions in which the dissolved active ingredients does not agglomerate and/or not crystalize out up on dilution with water. If a dispersion concentrate is not stable after dilution, it is not suitable for the commercial use because the forming large crystals will clog the spray equipment of farmers.

CIPAC MT 180 dispersion stability test was used to check stability of DC 1 to DC 15 after dilution in water. The results are given in table 1. As it seen in examples DC 1 to DC 10, DC 12 and DC 14, it is possible to obtain dispersion concentrates, which are stable after dilution water. If the claimed graft polymers are not used like in case of comparative examples DC 11 ,DC 13 and DC 15, the formulated active ingredients crystalize and flocculate. Those comparative compositions could not be used in spray applications. The experiments showed that the polymeric additives used according to the invention are suitable to improve the stability of dispersion concentrates of various pesticides after dilution.

TABLE 1
Dispersion concentrates and their stability upon dilution (“homog.” Shall mean “homogenous”)

| Ingredients | DC 1 | DC 2 | DC 3 | DC 4 | DC 5 | DC 6 | DC 7 | DC 8 | DC 9 |
|---|---|---|---|---|---|---|---|---|---|
| Fluxapyroxad | | | | | | | | | 3.7% |
| Metyltetraprole | | | | | | | | | 3.7% |
| Pyraclostrobin | 10.0% | 15.0% | 10.0% | 10.0% | 10.0% | 10.0% | | | |
| Mefentrifluconazol | | | | | | | | | |
| Saflufenacil | | | | | | | 8.0% | 8.0% | |
| Surfactant A | 5.0% | | 5.0% | 5.0% | 5.0% | 5.0% | | 5.0% | 4.7% |
| Surfactant B | 5.0% | | 5.0% | 5.0% | 5.0% | 5.0% | | 5.0% | 4.7% |
| Surfactant C | | | | | | | 10.0% | | |
| Polymeric additive A | 30.0% | 30.0% | 30.0% | 30.0% | 30.0% | 30.0% | 30.0% | 10.0% | 28.0% |
| Polymeric additive B | | | | | | | | | |
| Benzyl alcohol | 50.0% | | | | | | | | |
| N-acetyl morpholine | | | | | 50.0% | | | | |
| DMSO | | | | 50.0% | | | | | |
| N,N-dimethyl lactamide | | 55.0% | 50.0% | | | | | | 55.2% |
| Cyclohexanon | | | | | | 50.0% | 52.0% | 72.0% | |

The dispersion stability was tested according to CIPAC MT 180.
1% w/w solutions of formulation were prepared in CIPAC D water

| | | | | | | | | | |
|---|---|---|---|---|---|---|---|---|---|
| Initial | Homog. | Homog. | Homog. | Homog. | Homog. | Homog. | Homog. | Homog. | Homog. |
| | (Opaque- | (Opaque- | (Opaque- | (Opaque- | (Opaque- | (Opaque- | (Opaque- | (Opaque- | (Opaque- |
| | clear | clear | clear | clear | clear | clear | clear | clear | clear |
| | solution) | solution) | solution) | solution) | solution) | solution) | solution) | solution) | solution) |
| 2 hours | Homog | Homog | Homog | Homog | Homog | Homog | Homog | Homog | Homog |
| | (Opaque- | (Opaque- | (Opaque- | (Opaque- | (Opaque- | (Opaque- | (Opaque- | (Opaque- | (Opaque- |
| | clear | clear | clear | clear | clear | clear | clear | clear | clear |
| | solution) | solution) | solution) | solution) | solution) | solution) | solution) | solution) | solution) |

| | | Comparative | | Comparative | | Comparative |
|---|---|---|---|---|---|---|
| Ingredients | DC 10 | DC 11 | DC 12 | DC 13 | DC 14 | DC 15 |
| Fluxapyroxad | 4.7% | 4.7% | 3.7% | 3.7% | | |
| Metyltetraprole | | | 3.7% | 3.7% | | |
| Pyraclostrobin | | | | | 3.7% | 3.7% |
| Mefentrifluconazol | | | | | 3.7% | 3.7% |
| Surfactant A | 4.7% | 4.7% | | | | |
| Surfactant B | 4.7% | 4.7% | | | | |
| Polymeric additive A | 28.0% | | 28.0% | | | |
| Polymeric additive B | | | | | 40.2% | |
| Benzyl alcohol | | | | | | 12.6% |
| N,N-dimethyl lactamide | 57.9% | 85.9% | 64.6% | 92.6% | 52.4% | 80.0% |
| Viscosity η(s) [mPas] ¹⁾ | — | — | — | — | 38 | — |

The emulsion stability was tested according to CIPAC MT 180.
1% w/w solutions of formulation were prepared in CIPAC D water

| | | | | | | |
|---|---|---|---|---|---|---|
| Initial | Homog. | Homog. | Homog. | Flocculated | Homog. | Flocculated |
| | (Opaque- | (Opaque- | (Opaque- | active | (Opaque- | active |
| | clear | clear | clear | | clear | |
| | solution) | solution) | solution)) | | solution) | |
| 2 hours | <0.05 ml | Flocculated | Homogenous | Flocculated | Homogenous | Flocculated |
| | Krist. | active | (Opaque- | active | (Opaque- | active |
| | | | clear | | clear | |
| | | | solution) | | solution) | |

¹⁾ The viscosities were measured according to CIPAC MT 192 by using a rotational viscometer. The given values are the apparent viscosity which were determined at shear rate of 100 s-1.

### Example 16: Biology (Green House)

The pesticidal activity was tested in the greenhouse on wheat variety Monopol®, which was infected with the fungi Puccinia Recondata/Tritici (PUCCRT). The plants were treated with formulations three days after the inoculation at the use rate of 600 ppm (Pesticide A Pyraclostrobin+Mefentrifluconazol) per ha (200 l water/ha). The percentage of the infected leaf surface areas (7 days after inoculation) are summarized in Green House Table 2.

TABLE 2
Green House Data

| | Disease (%) at | Disease (%) at |
|---|---|---|
| | 1000 ppm | 125 ppm |
| Formulation | PUCCRT | PUCCRT |
| Untreated | 80% | 80% |
| control | | |
| DC 12 | 0% | 2% |

According to greenhouse trial test results which are presented in Table 2, the dispersion concentrate DC 14 comprising 40.2% of Polymeric additive B showed excellent fungicidal activity. DC Formulations according to the invention also showed better fungicidal activity compared to suspension concentrates having identical fungicide loadings and containing no polymer P.

The examples given in table 1, it was shown that the claimed polymeric additives are suitable to improve the stability of dispersion concentrates upon dilution and do not cause strong increase of their viscosity. It was shown that they increase the biological performance of pesticides if they are used in dispersion concentrates.

1. An agrochemical composition comprising
A) at least one pesticide A,
B) at least one nonaqueous solvent S,
C) a polymer P comprising units represented by formulae (I) and (II): 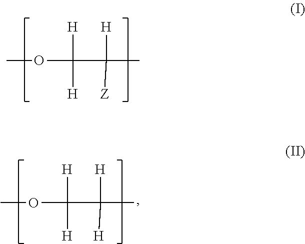
polymer P being a random polymer with respect to units (I) and (II);
wherein Z is a polymeric group comprising at least one type of vinyl monomer in polymerized form, where Z comprises as vinyl monomers at least one vinyl ester and optionally at least one N-vinyl lactam monomer;
wherein said pesticide A and polymer P are completely dissolved in said solvent S at 20° C.

2. The agrochemical composition according to claim 1, wherein said vinyl ester is vinyl propionate, vinyl acetate, or a mixture thereof.

3. The agrochemical composition according to claim 1, wherein said N-vinyl lactam is selected from N-vinyl pyrrolidone, N-vinyl caprolactam, or a mixture thereof.

4. The agrochemical composition according to claim 1, wherein polymeric group Z comprises vinyl ester and N-vinyl lactam, wherein a weight ratio of vinyl ether to N-vinyl lactam is 1:3 to 3:1.

5. The agrochemical composition according to claim 1, wherein polymer P bears in the terminal positions of the polyoxyalkylene chain a hydroxy or a C₁ to C₂₂ linear or branched alkyl ether group.

6. The agrochemical composition according to claim 1, wherein polymeric group Z is 45 to 75 wt % of polymer P.

7. The agrochemical composition according to claim 1, the wherein a combined average number of units (I) and (II) per polymer molecule is 6 to 200.

8. The agrochemical composition according to claim 1, wherein polymer P is obtained by a free radical polymerization of a monomer mixture comprising i) an alcohol ethoxylate or polyethylene oxide, ii) a vinyl ester, and iii) optionally an N-vinyl lactam.

9. The agrochemical composition according to claim 8, wherein polymer P is obtained from a monomer mixture comprising
i) 10 to 80% by weight of polyethylene glycol and/or alcohol alkoxylate (e.g. C₈₋₂₂ alcohol ethoxylate),
ii) 5 to 70% by weight of a vinyl ester,
iii) 0 to 60% by weight of N-vinyl lactam (e.g. N-vinyl pyrrolidone), and
iv) up to 20%,
wherein the sum of component i) to iv) adds up to 100%.

10. The agrochemical composition according to claim 10, wherein said alcohol ethoxylate is based on a C₈-C₂₂ alcohol.

11. The agrochemical composition according to claim 1, wherein said polymer P is represented by formula (IV): 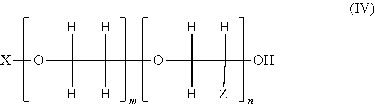
wherein each X is hydrogen or a C₁-C₂₂linear or branched alkyl group,
m is a number from 5 to 150,
n is a number from 1 to 30,
polymer P being a random polymer.

12. The agrochemical composition according to claim 1, wherein said composition is a dispersible concentrate.

13. The agrochemical composition according to claim 1, wherein polymer P is present in the composition in an amount from 0.5 wt % to 60 wt %.

14. according to claim 1, comprising
A) 3% to 30% of at least one pesticide A,
B) 25% to 92% wt % at least one nonaqueous water miscible solvent S,
C) 5 to 45 wt % of a polymer P,
D) 0 to 30 wt % of nonionic and/or anionic surfactants different from polymer P, and
E) 0 to 30 wt % of further additives.

15. A method for controlling phytopathogenic fungi and/or undesired plant growth and/or undesired attack by insects or mites and/or for regulating the growth of plants, where the composition as defined in claim 1 is allowed to act on the particular pests, their habitat or the plants to be protected from the particular pest, the soil and/or on undesired plants and/or the useful plants and/or their habitat.
